(19) United States
(12) Patent Application Publication
(10) Pub. No.: US 2007/0183094 A1
(43) Pub. Date: Aug. 9, 2007

(54) INFORMATION RECORDING MEDIUM

(75) Inventor: Morimasa SASAKI, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/626,642

(22) Filed: Jan. 24, 2007

(30) Foreign Application Priority Data
Feb. 3, 2006 (JP) 2006-026479

(51) Int. Cl. G11B 23/02

(52) U.S. Cl. 360/132

(57) ABSTRACT

An information recording medium which is capable of holding a front cover in its closed state even if a large external force is applied. The information recording medium includes a casing body which has tape reels mounted for winding the magnetic tape, a front wall and a lower wall having an outlet formed for pulling out a magnetic tape, and a cover and a sliding section which open and close the outlet. The front cover is pivotally mounted to the casing body by a pair of support sections, for opening and closing a part of the outlet formed in the front wall of the casing body. The sliding section is slidably mounted to the lower wall of the casing body, for opening and closing a part of the outlet formed in the lower wall of the casing body.

### BACKGROUND OF THE INVENTION

1. Field of the Invention

The present invention relates to an information recording medium provided with a front cover and a sliding section that open and close an outlet for pulling out a magnetic tape.

2. Description of the Related Art

As an information recording medium of this kind, there is known a tape cartridge disclosed in Japanese Laid-Open Patent Publication (Kokai) No. 2000-137971. This tape cartridge is comprised of a casing body (shell) formed by a pair of tape reels (reels) having a magnetic tape wound therearound, an upper casing (upper half), and a lower casing (lower half), for rotatably accommodating the respective tape reels, a front cover (lid) pivotally mounted to the front end face of the casing body for opening and closing an outlet (pocket) for pulling out the tape from the casing body, a sliding section (sliding shutter) for opening and closing the bottom of the outlet, and a reel brake (reel locking member) for locking and unlocking the tape reels in a manner interlocked with the opening and closing operation (pivotal motion) of the front cover.

In this case, the front cover is comprised of a cover body (lid main body) and a pair of left and right support sections (arms) provided on opposite sides of the cover body, and is pivotally mounted on the casing body by fitting rotational shafts (shafts) provided on the respective support sections in bearings (bearing portions) formed in the upper casing. Further, the front cover is given a pivotal force in the direction of closing the outlet by a spring (lid spring) such that the outlet is opened by pivotally moving the front cover against the spring force of this spring. Further, engaging portions (reel locking member-engaging portions) are provided on foremost ends of the support sections. Further, the reel brake is comprised of a main body engaged with the tape reels, a pair of legs disposed on opposite sides of the main body, respectively, and elastic arms each having a lid-engaging portion on its foremost end, and disposed on one ends of the legs, respectively.

In this tape cartridge, when the front cover is pivotally moved in the direction of closing the outlet against the pivotal force given by the spring, the engaging portions of the front cover and protrusions of the reel brake are engaged with each other to thereby cause the reel brake to slide in the direction of unlocking the tape reels.

### SUMMARY OF THE INVENTION

By the way, tape cartridges of the above-mentioned kind are different in thicknesses of casing bodies according to their specifications. Referring to FIG. 11, in the tape cartridge 201 of this kind, the width of the cover body 102 of the front cover 101 is defined such that it approximately matches the thickness L1 of the casing body 202. Therefore, when the casing body 202 is configured to have a large thickness, the width L1 of the cover body 102 of the front cover 101 becomes larger according to the thickness L1 of the casing body 202. Further, in accordance with the increase in the width L1, the width L2 of each support section 103 of the front cover 101 is increased. In the tape cartridge 201, as shown in FIGS. 8 and 9, depending on the arrangement of the reel brake in the casing body, it is sometimes inevitable to dispose the engaging portions 104 (the above-described engaging portions of the front cover) which are engaged with the reel brake to cause the reel brake to slide, on inner surfaces 103a of the respective support sections 103, at respective locations away from lower end faces 103b of the support sections 103 (e.g., locations closer to the center in the direction of the width L2).

Further, as shown in FIG. 12, in the tape cartridge 201 of this kind, the width of the lower end faces 103b of the respective support sections 103 is set to a size approximately equal to the width of upper end faces 106a of respective side walls 106 of the sliding section 105 on the front cover 101 side. Therefore, as shown in FIGS. 10 and 11, when the front cover 101 is closed, the lower end faces 103b of the respective support sections 103, and the upper end faces 106a of the respective side walls 106 of the sliding section 105 toward the front cover 101 are normally in contact with each other or closely facing each other (see FIG. 12). For this reason, in the above state, even if an external force for pivotally moving the front cover is applied to the front cover 101, the lower end faces 103b of the respective support sections 103 and the upper end faces 106a of the respective side walls 106 of the sliding section 105 interfere with each other, whereby the pivotal motion of the front cover 101 is prevented.

From the study of the above-described tape cartridge 201, however, the present inventor found the following problems. In the tape cartridge 201, the support sections 103 of the front cover 101 are generally formed to be thin using a resin material. Therefore, when a large external force is applied thereto, the support sections 103, especially the lower ends thereof are easily elastically deformed. Consequently, when a large external force is applied as when it has fallen from a height, the support sections 103 are deformed, whereby the lower end faces 103b thereof and the upper end faces 106a of the respective side walls 106 of the sliding section 105 are displaced from each other (the interfering state thereof is lost), but e.g., as shown in FIGS. 13 and 14, the lower ends of the support sections 103 climb onto the outer surfaces of the side walls 106, or inversely as shown in FIGS. 15 and 16, the lower ends of the support sections 103 enter the inside of the side walls 106. In the above states, an opening 202a to be closed by the front cover 101 remains half open. As a consequence, this tape cartridge 201 suffers from the problem that when a large external force is applied thereto, foreign matter can enter the same, resulting in breakage of the magnetic tape.

The present invention has been made in view of these problems, and a main object of the present invention is to provide an information recording medium which is capable of holding a front cover in its closed state even if a large external force is applied thereto.

To attain the above main object, the present invention provides an information recording medium comprising: a casing body that has a tape reel mounted thereon for winding a magnetic tape therearound, a front wall, a lower wall, and an outlet formed in the front wall and the lower wall, for pulling out the magnetic tape therefrom; a front cover including a cover body, and a pair of support sections erected on opposite ends of the cover body, the support sections being fitted on respective portions of a pair of side walls of the casing body in contact with the front wall thereof, the portions being at respective locations toward the front wall, whereby the front cover is pivotally mounted on the casing body, for opening and closing the outlet formed in the front wall, using the cover body; a reel brake that is disposed in the casing body and is configured to slide in a direction toward or away from the tape reel in a manner interlocked with opening and closing operations of the front cover; and a sliding section that is slidably mounted on the lower wall, for opening and closing the outlet formed in the lower wall, the sliding section having a pair of side walls formed thereon in a manner covering lower portions of the side walls of the casing body, wherein in a state in which the outlet is closed by the front cover and the sliding section, a pivotal motion of the front cover can be inhibited by abutment of respective upper end faces of the side walls of the sliding section with associated lower end faces of the respective support sections of the front cover, and wherein respective inner surfaces of the support sections have engaging portions formed thereon at respective locations spaced from the lower end faces of the support sections, for being engaged with the reel brake in a manner interlocked with the opening operation of the front cover to thereby cause the reel brake to slide in a direction away from the tape reel, and protrusions formed thereon in the vicinity of the lower end faces of the support sections.

According to this information recording medium, the engaging portions which are engaged with the reel brake to thereby cause the reel brake to slide in the direction away from the tape reel are formed on the inner surfaces of the respective support sections of the front cover, at respective locations spaced from the lower end faces, and the protrusions are formed in the vicinity of the lower end faces. Therefore, even if an unexpected external force is applied to the front cover in the closed position, causing the lower ends of the support sections to be slightly moved (expanded) toward the outsides of the side walls of the casing body, to thereby place the lower end faces of the support sections in a state in which the lower end faces are not in abutment with the upper end faces of the side walls, the protrusions maintain abutment with the upper end faces in the thickness direction of the side walls of the sliding section, and hence it is possible to reliably prevent the upward pivotal motion of the front cover (pivotal motion of the front cover in the opening direction thereof). This makes it possible, even when a large external force is applied to the front cover, to prevent foreign matter from entering the inside of the information recording medium, and consequently makes it possible to reliably avoid breakage of the magnetic tape.

The protrusions may be formed such that lower end faces thereof are flush with the lower end faces of the support sections. According to the information recording medium with this arrangement, it is possible to minimize the pivotal motion of the front cover when an unexpected external force is applied to the front cover in the closed position. Further, when the protrusions are brought into abutment with the upper end faces of the side walls of the sliding section, it is possible to disperse a force transmitted from the upper end faces to the protrusions, thereby making it possible to prevent breakage of the protrusions to favorably avoid breakage of the front cover and the sliding section. As a result, it is possible to improve the durability of the information recording medium.

The protrusions may be each formed in the vicinity of a side end face farthest from the cover body of all side end faces of each support section. According to this information recording medium, each of the protrusions is formed in the vicinity of the side end face farthest from the cover body of all the side end faces of the inner surface of each support section, whereby when the front cover is about to be pivotally moved by an unexpected external force, it is possible to minimize the external force applied to the protrusions by virtue of the principles of the lever and fulcrum. This makes it possible to avoid breakage of the protrusions, and further more favorably avoid breakage of the front cover and the sliding section. As a result, it is possible to further improve the durability of the information recording medium.

It should be noted that the present disclosure relates to the subject matter included in Japanese Patent Application No. 2006-26479 filed Feb. 3, 2006, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is an exploded perspective view of an information recording medium;

FIG. 2 is an enlarged view of essential parts of a connecting portion and its vicinity on a side wall of an upper casing;

FIG. 3 is a perspective view of a front cover;

FIG. 4 is a cross-sectional view of the FIG. 3 front cover, taken on line X1-X1 of FIG. 3;

FIG. 5 is a side view of the information recording medium in a state in which the front cover and a sliding section are in a closed position;

FIG. 6 is a side view of the information recording medium in a state in which the front cover and the sliding section are in an open position;

FIG. 7 is a cross-sectional view of the side wall and its vicinity of the FIG. 5 information recording medium, taken on line Y1-Y1 of FIG. 5;

FIG. 8 is a perspective view of a conventional front cover and a conventional sliding section;

FIG. 9 is a cross-sectional view of the FIG. 8 front cover, taken on line X2-X2 of FIG. 8;

FIG. 10 is a perspective view of essential parts of the front cover and the sliding section, which is useful in explaining the positional relationship between the front cover and the sliding section in a state in which the front cover is closed;

FIG. 11 is a side view of a tape cartridge in a state in which the front cover and the sliding section are in the closed position;

FIG. 12 is a cross-sectional view of a side wall toward the viewer and its vicinity of the FIG. 11 tape cartridge, taken on line Y2-Y2 of FIG. 11;

FIG. 13 is a side view of the tape cartridge in a state in which the front cover is half open;

FIG. 14 is a cross-sectional view of the side wall toward the viewer and its vicinity of the FIG. 13 tape cartridge, taken on line Y3-Y3 of FIG. 13;

FIG. 15 is a side view of the tape cartridge in a state in which the front cover is half open; and

FIG. 16 is a cross-sectional view of the side wall toward the viewer and its vicinity of the FIG. 15 tape cartridge, taken on line Y4-Y4 of FIG. 15.

### DESCRIPTION OF THE PREFERRED EMBODIMENTS

Hereinafter, the best mode of an information recording medium according to the present invention will be described with reference to the accompanying drawings.

First, a description will be given of the construction of the information recording medium 1 with reference to the drawings.

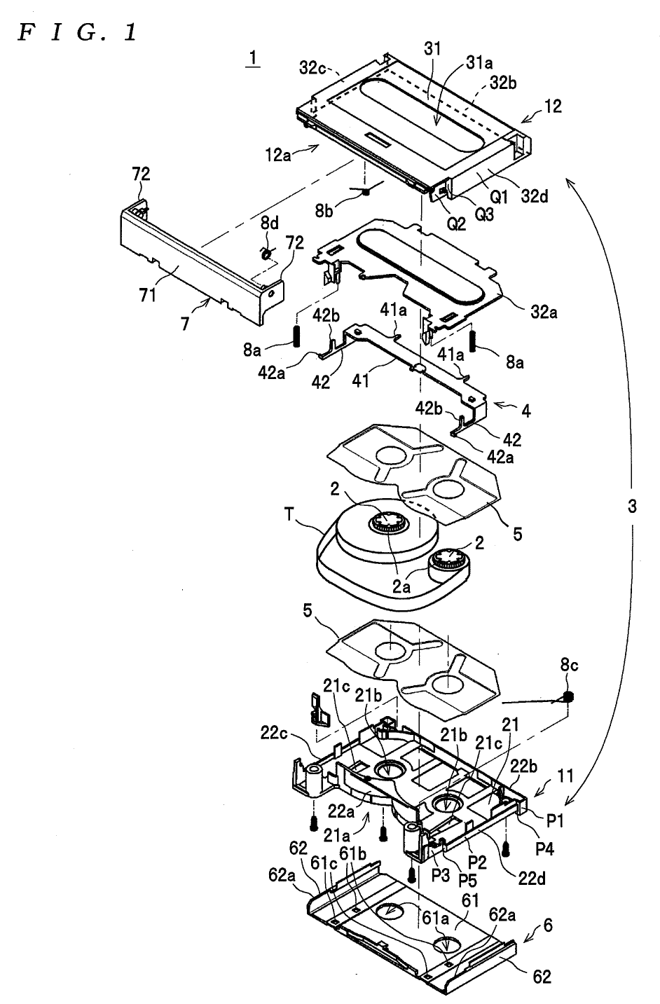

Referring to FIG. 1, the information recording medium 1 is a two-reel cartridge type information recording medium for use as a storage device for backing up data recorded on an electronic computer, and is comprised of tape reels 2 wound with a magnetic tape T, a casing body 3, a reel brake 4, sheets 5, a sliding section 6, and a front cover 7, as shown in FIG. 1.

Each tape reel 2 is accommodated within the casing body 3 with the magnetic tape T wound therearound. Further, as shown in FIG. 1, each tape reel 2 has one end (an upper end, as viewed in FIG. 1) thereof formed with teeth 2a with which a protrusion 41a of the reel brake 4 is engaged for thereby restricting the rotation of the tape reel.

Referring to FIG. 1, the casing body 3 is comprised of a lower casing 11 and an upper casing 12, which are capable of being fitted to each other, and is configured to form a box the outer shape of which is generally rectangular parallelepiped when the casings 11 and 12 are fitted to each other. The casing body 3 rotatably accommodates the tape reels 2 in an internal space thereof. As shown in FIG. 1, the lower casing 11 is comprised of a bottom board 21, a front wall 22a, a rear wall 22b, and a pair of side walls 22c and 22d, and is formed to be a generally shallow plate overall shape.

The bottom board 21 forms a lower wall of the casing body 3 in the present invention, and has a cutaway portion 21a formed at a central portion thereof on a front side (toward the front cover 7) as viewed when inserting the information recording medium 1 into a drive unit. In this case, an outlet 3a (see FIG. 6) for pulling out the magnetic tape T therefrom is formed by the cutaway portion 21a and an opening 12a of the upper casing 12, described hereinafter. Further, the bottom board 21 is formed with circular insertion holes 21b for inserting drive shafts of the drive unit therethrough. Further, formed on the side toward the cutaway portion 21a of the bottom board 21 are arm-shaped locking portions 21c for locking the sliding section 6 in a non-slidable state. In this case, each locking portion 21c has a foremost end thereof urged toward the sliding section 6 by an associated one of springs 8a appearing in FIG. 1.

Further, as shown in FIG. 1, the front wall 22a, the rear wall 22b, and the pair of side walls 22c and 22d, of the lower casing 11, are erected on the front side edge, the rear side edge, and the left and right side edges of the bottom board 21, respectively. Further, the side walls 22c and 22d form a pair of side walls of the casing body in the present invention together with respective side walls 32c and 32d of the upper casing 12, described hereinafter. Further, respective rearward portions P1 of the side walls 22c and 22d are formed to be in contact with the rear wall 22b and parallel to each other, and are defined such that the distance therebetween is equal or approximately equal to the distance between rearward portions Q1 of the pair of side walls 32c and 32d of the upper casing 12, described hereinafter. Further, respective intermediate portions P2 of the side walls 22c and 22d are formed parallel to each other at locations forward of the rearward portions P1, and are defined such that the distance therebetween is made shorter than the distance between the rearward portions P1 by the thickness of the side walls 62 of the sliding section 6, described hereinafter.

Further, respective forward portions P3 of the side walls 22c and 22d are formed parallel to each other at locations forward of the intermediate portions P2 (forward of the front wall 22a), and are defined such that the distance therebetween is made even shorter than the distance between the intermediate portions P2. More specifically, the distance between the forward portions P3 is set by taking into account the protruding lengths of engaging portions 72b and protrusions 72c formed on a cover body 71 of the front cover 7, described hereinafter, and the thickness of arms 42 of the reel brake 4. Further, connecting portions P4 of the side walls 22c and 22d are formed to be parallel to the rear wall 22b at respective locations between the rearward portion P1 and the intermediate portion P2, and connect between the portions P1 and P2. Furthermore, connecting portions P5 of the side walls 22c and 22d are formed to be parallel to the rear wall 22b at respective locations between the intermediate portion P2 and the forward portion P3, and connect between the portions P2 and P3. In this case, the above-described intermediate portions P2 form lower portions in the present invention, which are covered with the respective side walls 62 of the sliding section 6, as described hereinafter. The rear wall 22b of the lower casing 11 forms a rear wall of the casing body 3 together with a rear wall 32b of the upper casing 12.

Referring to FIG. 1, the upper casing 12 is comprised of a top board 31, a window portion 32a, the rear wall 32b, and the pair of side walls 32c and 32d, and are formed to be shallow plate-shaped with the opening 12a formed on the front surface side (toward the front cover 7). The top board 31 is formed to have a generally rectangular overall shape. Further, the top board 31 has a central portion formed with a top window 31a which is closed by the transparent (or substantially transparent) window portion 32a attached to an inner surface of the top board 31.

The rear wall 32b, and the pair of side walls 32c and 32d are erected on a rear side edge and left and right side edges of the top board 31. Further, the rearward portions Q1 of the side walls 32c and 32d are formed to be in contact with the rear wall 32b, respectively, and parallel to each other, and defined such that the distance therebetween is equal or approximately equal to the distance between the rearward portions P1 of the side walls 22c and 22d of the lower casing 11. Further, the length (length in the front-rear direction) of each rearward portion Q1 is defined to be equal or approximately equal to the total length (total length in the front-rear direction) of the length of the rearward portion P1 and the length of the intermediate portion P2 of each of the side walls 22c and 22d of the lower casing 11. Further, respective forward portions Q2 of the side walls 32c and 32d are formed parallel to each other at respective locations forward of the rearward portions Q1, and the locations of the respective forward portions Q2 and the distance therebetween are defined such that the forward portions Q2 are associated with the respective forward portions P3 of the side walls 22c and 22d (opposite end faces of these portions Q2 and P3 are brought into contact with each other when the lower casing 11 and the upper casing 12 are fitted to each other). Furthermore, connecting portions Q3 of the side walls 32c and 32d are formed to be parallel to the rear wall 32b, at respective locations between the rearward portion Q1 and the forward portion Q2, and connect between the portions Q1 and Q2. Further, the locations of the respective connecting portions Q3 are defined such that the connecting portions Q3 are associated with the connecting portions P5 of the respective side walls 22c and 22d of the lower casing 11 (opposite end faces of these portions Q3 and P5 are brought into contact with each other when the lower casing 11 and the upper casing 12 are fitted to each other).

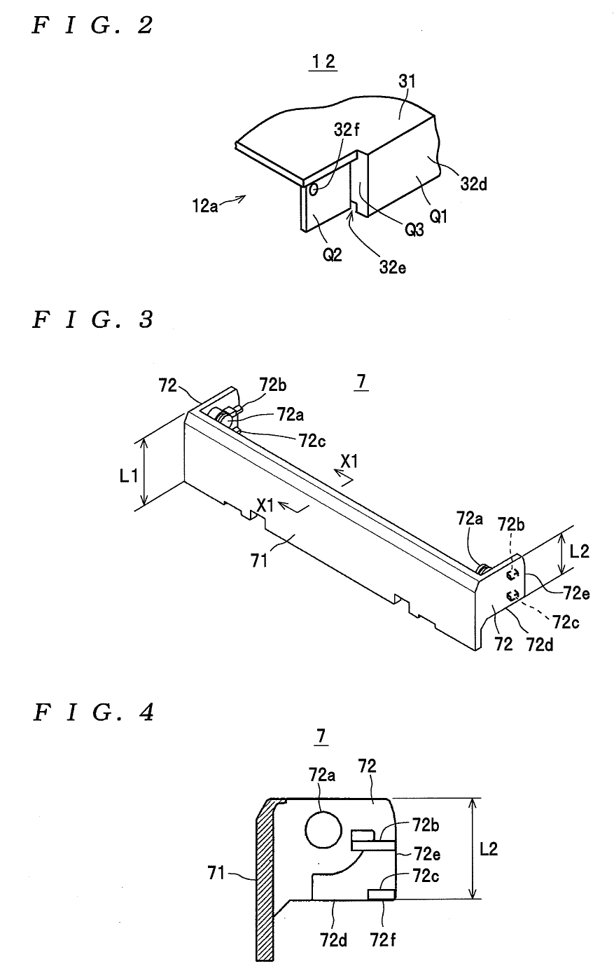

Further, as shown in FIG. 2, the connecting portion Q3 of the side wall 32d has a lower end formed with a cutaway portion 32e into which is inserted an associated one of the arms 42 of the reel brake 4, described hereinafter. Further, the forward portion Q2 of the side wall 32d is formed with a bearing 32f in which is fitted a rotational shaft 72a formed on an associated one of support sections 72 of the front cover 7, described hereinafter. Further, although not shown, the connecting portion Q3 of the side wall 32c as well has a lower end formed with a cutaway portion 32e into which the other arm 42 of the reel brake 4 is inserted, and the forward portion Q2 of the side wall 32c as well is formed with a bearing 32f in which is fitted a rotational shaft 72a formed on the other support section 72 of the front cover 7.

Referring to FIG. 1, the reel brake 4 is comprised of a main body 41, and the arms 42. As shown in FIGS. 5 and 6, the main body 41 is disposed within the casing body 3 in a slidable manner in a direction toward or away from the tape reels 2 (in the front-rear direction of the casing body 3), and is always urged by a spring 8b appearing in FIG. 1 in a direction in which the main body 41 is moved toward the tape reels 2. Further, the main body 41 is formed with two protrusions 41a. In this case, as shown in FIG. 5, when the main body 41 is close to the tape reels 2, the protrusions 41a are engaged with the teeth 2a of the tape reels 2, respectively, to thereby restrict the rotations of the tape reels 2. Further as shown in FIG. 6, when the main body 41 is spaced from the tape reels 2, the protrusions 41a are disengaged from the teeth 2a of the tape reels 2, to thereby cancel the restriction of the rotations of the tape reels 2.

As shown in FIG. 1, the arms 42 are formed parallel to each other in a manner protruding from the opposite ends of the main body 41 toward the front cover 7. Further, each foremost end of the arms 42 toward the front cover 7 has an outer surface thereof formed with a protrusion 42a laterally protruding therefrom. Further, each central portion of the arms 42 has an upper surface thereof formed with another protrusion 42b protruding upward therefrom. As shown in FIG. 6, parts of the arms 42 between the protrusion 42b and the main body 41, are slidably inserted into the cutaway portions 32e formed in the connecting portions Q3 of the side walls 32c and 32d of the upper casing 12, and each foremost side of the arms 42, formed with the protrusions 42a and 42b, extends along an associated one of the outer surfaces of the forward portions Q2 of the side walls 32c and 32d, outside the upper casing 12. Further, each foremost side of the arms 42 formed with the protrusions 42a and 42b (portion extending along the surface of each forward portion Q2) enters an area between one of the outer surfaces of the forward portions Q2 of the respective side walls 32c and 32d and an associated one of the inner surfaces of the respective support sections 72 of the front cover 7. Further, the foremost sides of the respective arms 42 slide in the front-rear direction of the casing body 3 in the vicinity of lower end faces of the side walls 32c and 32d of the upper casing 12 within the above areas, in a state parallel to the lower surfaces.

The sheets 5 are formed e.g., of a resin material, and have the functions of causing the tape reels 2 to rotate smoothly, and preventing motions of the magnetic tape T in the direction of the width thereof to thereby cause the magnetic tape T to be neatly taken up by the tape reels 2. To this end, the sheets 5 are arranged such that they sandwich the tape reels 2 and the magnetic tape T wound around the tape reels 2 therebetween.

As shown in FIG. 1, the sliding section 6 is comprised of a main body 61 and the side walls 62. The main body 61 is in the form of a rectangular plate. Further, the main body 61 is formed with circular insertion holes 61a for having the drive shafts of the drive unit inserted therethrough. Further, the main body 61 has a pair of engaging holes 61b and a pair of engaging holes 61c formed at respective locations toward the side walls 62 in areas which are forward of the insertion holes 61a and extend to the front end of the main body, respectively, in the mentioned order. On the other hand, the side walls 62 are erected on left and right side edges of the main body 61 in a state parallel to each other. Further, the side walls 62 are defined such that the distance therebetween is equal or approximately equal to the distance between the side walls 32c and 32d of the upper casing 12.

As shown in FIGS. 5 and 6, the sliding section 6 configured as above is slidably mounted to the casing body 3 in a state in which the main body 61 is in intimate contact with the lower surface of the bottom board 21 of the lower casing 11, and at the same time the side walls 62 are in intimate contact with the outer surfaces of the intermediate portions P2 of the side walls 22c and 22d of the lower casing 11 (in a state covering the outer surfaces of the intermediate portions P2). In this case, the sliding section 6 is configured to be slidable between a position (closed position shown in FIG. 5) where foremost ends of the respective locking portions 21c of the lower casing 11 are engaged with the engaging holes 61b, respectively, and a position (open position shown in FIG. 6) where the foremost ends of the respective locking portions 21c of the lower casing 11 are engaged with the engaging holes 61c, respectively. Further, the sliding section 6 is always urged by a spring 8c appearing in FIG. 1 toward the closed position.

Referring to FIGS. 3 and 4, the front cover 7 is comprised of the cover body 71, and the support sections 72 formed on opposite ends of the cover body 71. As shown in FIG. 5, the cover body 71 has a width L1 (see FIG. 3) defined to be approximately equal to the height of the casing body 3. As shown in FIGS. 3, 4, and 5, each support section 72 is formed to have a generally rectangular shape in side view (as viewed from a side of the casing body 3), and has a width L2 thereof defined to be approximately equal to the height of the upper casing 12. Further, the distance between the support sections 72 is set to be equal or approximately equal to the distance between the side walls 62 of the sliding section 6.

Further, as shown in FIGS. 3 and 4, each support section 72 has an inner surface (surface facing the other support section 72) formed with the rotational shaft 72a, the engaging portion 72b, and the protrusion 72c. In this case, the engaging portion 72b has the function that when the front cover 7 is pivotally moved upward, the engaging portion 72b is engaged with the protrusion 42a of the reel brake 4, to thereby cause the reel brake 4 to slide in a direction away from the tape reel 2, and is formed at a location spaced from the lower end face 72d of the support section 72. More specifically, as shown in FIGS. 4 and 5, the engaging portion 72b is formed in the vicinity of a rear end face 72e of each support section 72 at an approximately intermediate location of the support section 72 in the direction of the width L2. Now, the term “lower end face 72d of each support section 72” is intended to mean an end face of the support section 72, which faces an upper end face 62a (see FIGS. 1 and 5) of each of the side walls 62 of the sliding section 6, when the front cover 7 is in a position for closing the opening 12a (closed position).

On the other hand, the protrusions 72c are formed in the vicinity of the lower end faces of the respective support sections 72 in a manner protruding in directions in which the protrusions 72c face each other. More specifically, as shown in FIGS. 4, 5, and 6, each protrusion 72c is in the form of a rectangular parallelepiped, for example, and is disposed such that the direction of the length thereof becomes parallel to the lower end face 72d at a corner portion formed by the lower end face 72d and the rear end face 72e of each support section 72, that is, at a location farthest from the cover body 71. In other words, the protrusion 72c is formed in the vicinity of a side end face (rear end face 72e) farthest from the cover body 71 of all the side end faces of each the support section 72. Further, a lower end face 72f of the protrusion 72c is formed to be flush with the lower end face 72d of each support section 72. The rotational shafts 72a of the support sections 72 are fitted in the bearings 32f (see FIG. 2) formed in the respective forward portions Q2 (portions of a pair of side walls of a casing body at respective locations toward a front wall, in the present invention) of the side walls 32c and 32d of the upper casing 12, whereby the front cover 7 configured as described above is mounted to the upper casing 12 in a manner pivotally movable about the bearings 32f. Further, the front cover 7 is always urged by a spring 8d appearing in FIG. 1 in the direction of closing the opening 12a of the upper casing 12.

Next, operations of the component elements of the information recording medium 1 will be described with reference to drawings.

In a state in which the information recording medium 1 is removed from the drive unit, not shown, that is, when the information recording medium 1 is not in use, as shown in FIG. 5, the front cover 7 is pivotally moved downward by the urging force of the spring 8d, to be in the closed position for closing the opening 12a of the upper casing 12, and at the same time the sliding section 6 is moved toward the front cover 7 by the urging force of the spring 8c, to be in a closed position for closing the cutaway portion 21a formed in the bottom board 21 of the lower casing 11. This causes the outlet 3a formed by the opening 12a and the cutaway portion 21a to be closed by the front cover 7 and the sliding section 6. In this case, the foremost ends of the respective locking portions 21c of the lower casing 11 are engaged with the pair of engaging holes 61b, whereby the rearward motion of the sliding section 6 is restricted (the sliding section 6 is locked in the non-slidable state).

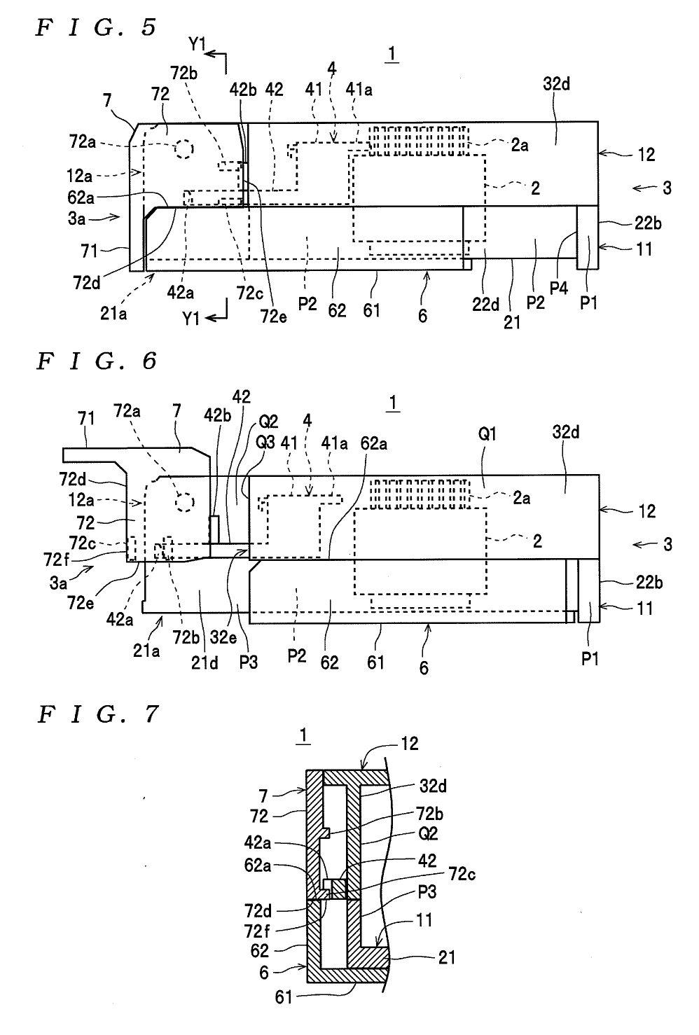

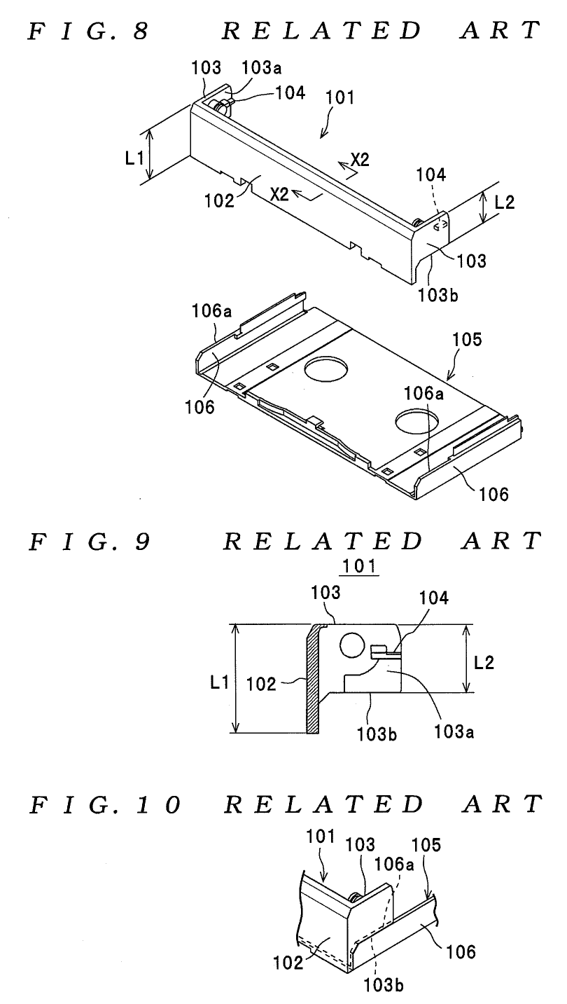

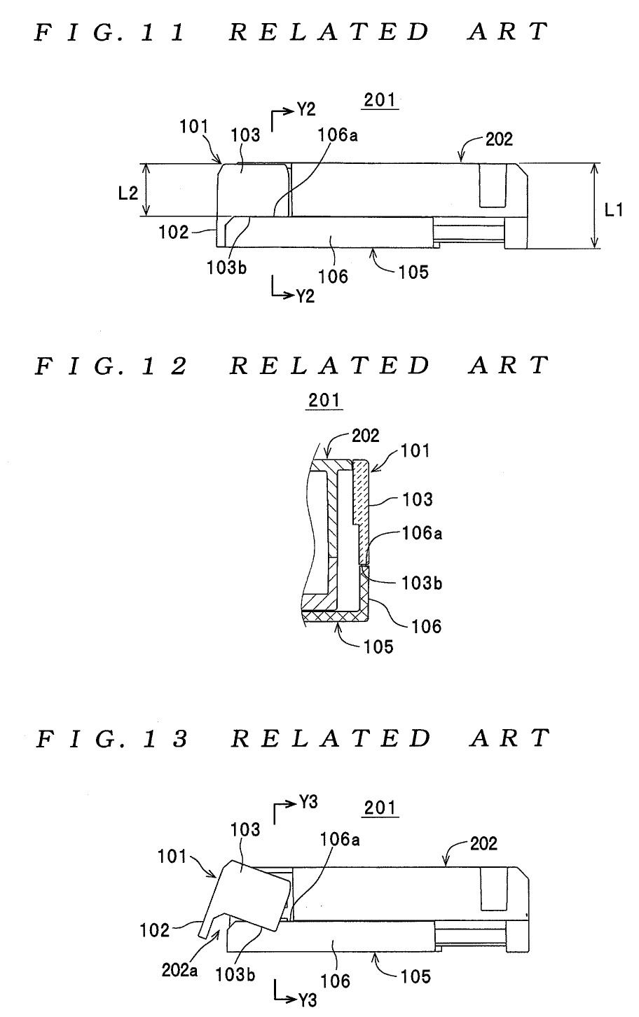

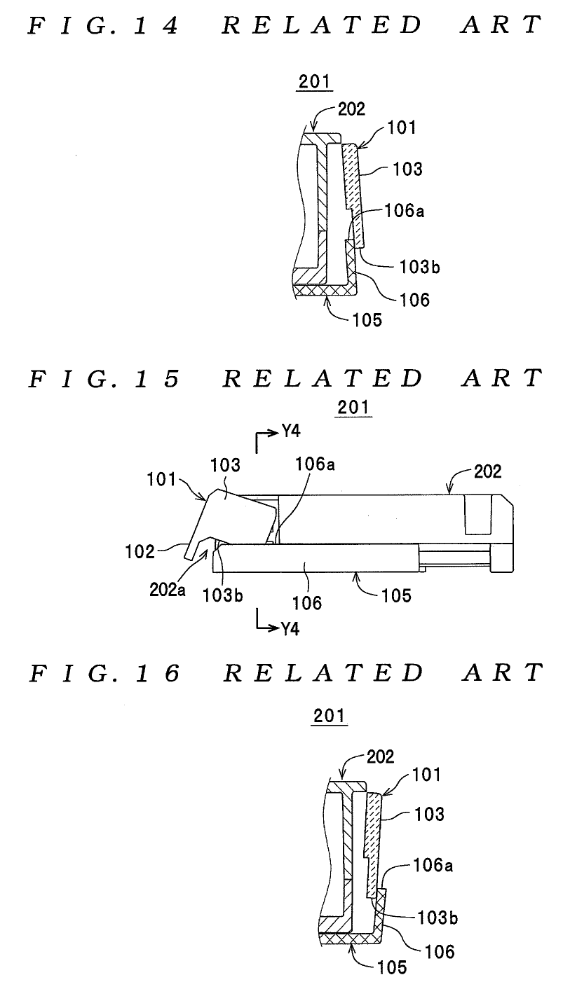

Further, as shown in FIGS. 5 and 7, the lower end faces 72d of the respective support sections 72 of the front cover 7, and the upper end faces 62a of the side walls 62 of the sliding section 6 face each other in a state in which they are close to or in contact with each other. As a result, even if the front cover 7 is about to be pivotally moved upward, the lower end faces 72d of the respective support sections 72 interfere with the upper end faces 62a of the side walls 62, that is, the lower end faces 72d are brought into abutment with the upper end faces 62a, whereby the pivotal motion of the front cover 7 is restricted. Furthermore, the protrusions 72c are formed on the inner surfaces of the respective support sections 72 in the vicinity of the lower end faces 72d thereof (at locations flush with the lower end faces 72d of the support sections 72). Therefore, even if an unexpected external force is applied to the front cover 7 e.g., due to a fall of the information recording medium 1, causing the lower ends of the support sections 72 to be slightly moved (expanded) toward the outsides of the side walls 32c and 32d of the casing body 3 (leftward, as viewed in FIG. 7), to place the lower end faces 72d of the support sections 72 in a state in which the lower end faces 72d do not interfere with the upper end faces 62a of the side walls 62, that is, in a state in which the lower end faces 72d are not in abutment with the upper end faces 62a, the lower end faces 72f of the protrusions 72c enter the interfering state in which they closely face the upper end faces 62a of the side walls 62, in place of the lower end faces 72d of the support sections 72, that is, the lower end faces 72f of the protrusions 72c are brought into abutment with the upper end faces 62a. As described above, the amount of interference of the support sections 72 with the upper end faces 62a of the side walls 62 along the thickness of the upper end faces 62a is increased by the protrusions 72c, which prevents the front cover 7 from being pivotally moved upward due to an unexpected external force.

Further, as described above, as shown in FIGS. 5 and 6, the foremost sides of the respective arms 42 of the reel brake 4 slide in the state parallel to the lower end faces of the side walls 32c and 32d of the upper casing 12, within the areas between the support sections 72 of the front cover 7 and their associated forward portions Q2 of the side walls 32c and 32d, in the vicinity of the lower end faces of the side walls 32c and 32d. Therefore, as shown in FIG. 7, in the state in which the front cover 7 is in the closed position, the arms 42 of the reel brake 4 are positioned between the protrusions 72c formed on the respective inner surfaces of the support sections 72 and the forward portions Q2 of the side walls 32d. For this reason, even if an unexpected external force is applied to the front cover 7, causing the lower ends of the support sections 72 to attempt to move toward the insides of the side walls 32c and 32d (rightward, as viewed in FIG. 7), the protrusions 72c are brought into abutment with the arms 42, whereby the motions of the lower ends of the support sections 72 toward the insides of the side walls 32c and 32d are restricted. As a result, the facing state (interfering state) of the lower end faces 72d of the respective support sections 72 and their associated upper end faces 62a of the side walls 62 is maintained, which prevents the front cover 7 from being pivotally moved upward. It should be noted that although in FIG. 7, only the side wall 32d of the upper casing 12 is shown, the other side wall 32c and its associated parts are also configured, though not shown, similarly to the side wall 32d and its associated parts, such that the upward pivotal motion of the front cover 7 is prevented.

Further, in the closed state of the information recording medium 1 shown in FIG. 5, the reel brake 4 is moved toward the tape reels 2 by the urging force of the spring 8b, whereby the protrusions 41a formed on the main body 41 are placed in a state engaged with the teeth 2a of the tape reels 2, respectively. As a consequence, the rotations of the tape reels 2 are restricted by the reel brake 4.

On the other hand, when the information recording medium 1 is inserted into the drive unit, not shown, from an inlet toward a loading section thereof, the loading section draws the information recording medium 1 into the drive unit. In this case, the information recording medium 1 is drawn into the unit in a state in which the foremost ends of the locking portions 21c are in abutment with abutting portions, not shown, mounted in the vicinity of the inlet, so that the foremost ends of the locking portions 21c are pushed upward to be disengaged from the engaging holes 61b of the sliding section 6, whereby the sliding section 6 is released from the non-slidable state. Then, the sliding section 6 is caused to slide by the drive unit toward the rear wall 22b of the lower casing 11 against the urging force of the spring 8c (see FIG. 1). The sliding section 6 is caused to slide until the foremost ends of the locking portions 21c of the lower casing 11 are engaged with the engaging holes 61c of the main body 61 of the sliding section 6, respectively (until the state shown in FIG. 6 is brought about). In this state, the insertion holes 61a of the sliding section 6 and the insertion holes 21b of the lower casing 11 communicate with each other, and the cutaway portion 21a formed in the bottom board 21 of the lower casing 11 is opened. Further, the foremost ends of the respective locking portions 21c of the lower casing 11 are engaged with the engaging holes 61c of the main body 61 of the sliding section 6, whereby the sliding section 6 is locked in the non-slidable state. Subsequently, the loading section moves the information recording medium 1 toward the foremost ends of the drive shafts of the drive unit. In the meanwhile, the drive shafts are inserted through the insertion holes 61a and 21b into the central portions of the tape reels 2.

Then, the drive unit pivotally moves the front cover 7 upward against the urging force of the spring 8d, whereby as shown in FIG. 6, the opening 12a of the upper casing 12 is opened. At this time, the engaging portions 72b of the respective support sections 72 of the front cover 7 are engaged with the protrusions 42a formed on the foremost ends of the respective arms 42 of the reel brake 4 to thereby move the arms 42 toward the opening 12a. In accordance with the motion of the arms 42, the main body 41 of the reel brake 4 is slid in the direction away from the tape reels 2, against the urging force of the spring 8b. As a result, the teeth 2a of the tape reels 2 and the protrusions 41a of the main body 41 are disengaged from each other, to thereby release the restriction of the rotations of the tape reels 2.

As described above, in the information recording medium 1, the engaging portions 72b, which are engaged with the associated protrusions 42a of the reel brake 4 in a manner interlocked with the opening operation of the front cover 7 to thereby cause the reel brake 4 to slide in the direction away from the tape reels 2, are formed on the inner surfaces of the respective support sections 72 of the front cover 7, at respective locations spaced from the lower end faces 72d, and the protrusions 72c are formed in the vicinity of the lower end faces 72d (at locations flush with the lower end faces 72d, in the illustrated example). Therefore, according to the information recording medium 1, even if an unexpected external force is applied to the front cover 7 in the closed position e.g., due to a fall of the information recording medium 1, causing the lower ends of the support sections 72 to be slightly moved (expanded) toward the outsides of the side walls 32c and 32d of the casing body 3, to thereby place the lower end faces 72d of the support sections 72 in a state in which the lower end faces 72d are not in abutment (interference) with the upper end faces 62a of the side walls 62, the protrusions 72c maintain abutment with the upper end faces 62a of the side walls 62 along the thickness of the side walls 62 (that is, the amount of interference with the upper end faces 62a of the side walls 62 is increased by the protrusions 72c), and hence it is possible to reliably prevent the upward pivotal motion of the front cover 7 (pivotal motion of the front cover 7 in the opening direction thereof). This makes it possible, even when a large external force is applied to the front cover 7, to prevent foreign matter from entering the inside of the information recording medium 1, and consequently makes it possible to reliably avoid breakage of the magnetic tape T.

In this case, since the respective lower end faces 72f of the protrusions 72c are formed such that they are flush with the lower end faces 72d of the support sections 72, it is possible to minimize the pivotal motion of the front cover 7 in the closed position. Further, when the protrusions 72c are brought into abutment with the upper end faces 62a of the side walls 62, it is possible to disperse a force transmitted from the upper end faces 62a to the protrusions 72c, thereby making it possible to prevent breakage of the protrusions 72c and further more favorably avoid breakage of the front cover 7 and the sliding section 6. As a result, it is possible to improve the durability of the information recording medium 1.

Further, each of the protrusions 72c is formed in the vicinity of the side end face (rear end face 72e) farthest from the cover body 71 of all the side end faces of the inner surface of each support section 72 (at a location flush with the lower end face 72d, in the illustrated example), whereby when the front cover 7 is about to be pivotally moved by an external force, it is possible to minimize the external force applied to the protrusions 72c by virtue of the principles of the lever and fulcrum. This makes it possible to more favorably avoid breakage of the protrusions 72c, and further breakage of the front cover 7 and the sliding section 6. As a result, it is possible to further improve the durability of the information recording medium 1.

It should be noted that the present invention is by no means limited to the above-described configuration. For example, although the information recording medium 1 employs the configuration in which each protrusion 72c is formed at the corner portion formed by the lower end face 72d and the rear end face 72e within the inner surface of each support section 72, this is not limitative, but the protrusion 72c may be formed at any location which is in the vicinity of the lower end face 72d, and at the same time toward or closer to the rear end face 72e with respect to the rotational shaft 72a. Further, although it is preferable to form the protrusion 72c at a location where the lower end face 72f of the protrusion 72c is flush with the lower end face 72d of the support section 72, it is possible to dispose each protrusion 72c at any location slightly spaced from the lower end face 72d, within a range which makes it possible to avoid the lower end of each support section 72 climbing onto an outer surface of the side wall 62 of each sliding section 6 when the front cover 7 in the closed position is about to be pivotally moved by an unexpected external force. Further, although in the aforementioned embodiment, the description has been given of the example in which the width L1 of the cover body 71 of the front cover 7 is defined to be approximately equal to the height of the casing body 3, and the width L2 of each support section 72 is defined to be approximately equal to the height of the upper casing 12, this is not limitative, but the widths L1 and L2 can be changed as required. Furthermore, it is understood that the shapes and the sizes of the component elements other than the front cover can be changed as required.

Further, for example, although in the above-described embodiment, the description has been given, by way of example, of the information recording medium 1 for use in backing up data recorded on an electronic computer, the present invention can be applied to various information recording media, such as an information recording medium for use in recording image data, and an information recording medium for use in recording voice data. Further, although in the above-described embodiment, the description has been given of the information recording medium 1 provided with two tape reels 2, by way of example, the present invention can be applied to an information recording medium provided with a single tape reel.

What is claimed is:

1. An information recording medium comprising:
a casing body that has a tape reel mounted thereon for winding a magnetic tape therearound, and includes a front wall, a lower wall, and an outlet formed in the front wall and the lower wall, for pulling out the magnetic tape therefrom;
a front cover including a cover body, and a pair of support sections erected on opposite ends of the cover body, the support sections being fitted on respective portions of a pair of side walls of the casing body in contact with the front wall thereof, the portions being at respective locations toward the front wall, whereby the front cover is pivotally mounted on the casing body, for opening and closing the outlet formed in the front wall, using the cover body;
a reel brake that is disposed in the casing body and is configured to slide in a direction toward or away from the tape reel in a manner interlocked with opening and closing operations of the front cover; and
a sliding section that is slidably mounted on the lower wall, for opening and closing the outlet formed in the lower wall, the sliding section having a pair of side walls formed thereon in a manner covering lower portions of the pair of side walls of the casing body,
wherein in a state in which the outlet is closed by the front cover and the sliding section, a pivotal motion of the front cover can be inhibited by abutment of respective upper end faces of the side walls of the sliding section with associated lower end faces of the respective support sections of the front cover, and
wherein respective inner surfaces of the support sections have engaging portions formed thereon at respective locations spaced from the lower end faces of the support sections, for being engaged with the reel brake in a manner interlocked with the opening operation of the front cover to thereby cause the reel brake to slide in a direction away from the tape reel, and protrusions formed thereon in the vicinity of the lower end faces of the support sections.

2. An information recording medium according to claim 1, wherein the protrusions are formed such that lower end faces thereof are flush with the lower end faces of the support sections.

3. An information recording medium according to claim 1, wherein the protrusions are each formed in the vicinity of a side end face farthest from the cover body of all side end faces of each support section.
